(19) United States
(12) Patent Application Publication
(10) Pub. No.: US 2024/0109014 A1
(43) Pub. Date: Apr. 4, 2024

(54) TWO-WAY AIR INTAKE PURIFIER

(71) Applicant: Guangdong Cinotex Environmental Sci-Tech Co., Ltd., Zhongshan City (CN)

(72) Inventors: Haiyang LU, Zhongshan City (CN); Sigui DAI, Zhongshan City (CN)

(21) Appl. No.: 18/165,562

(22) Filed: Feb. 7, 2023

(30) Foreign Application Priority Data
Sep. 29, 2022 (CN) 202222619188.0

(51) Int. Cl. B01D 46/00

(52) U.S. Cl. CPC B01D 46/0047; B01D 2273/30

(57) ABSTRACT

A two-way air intake purifier includes a body and at least two fans, wherein a first air inlet is provided on each of two opposite sides of the body, a first air outlet is provided on a side adjacent to the two first air inlets on the body, each of the fans has two second air inlets arranged axially and a second air outlet arranged laterally, the fans are all arranged in the body, the two second air inlets of each of the fans are respectively facing the two first air inlets, the second air outlet of each of the fans is facing the first air outlet, and a filtering device is provided at the first air inlets and/or the second air inlets respectively. The two-way air intake purifier can increase the volume of air intake and outtake, facilitate overall circulation of indoor air, and improve the air purification efficiency.

### CROSS-REFERENCE TO RELATED APPLICATIONS

This application claims the benefit of Chinese Patent Application No. 20222261 9188.0, filed on Sep. 29, 2022 in the National Intellectual Property Administration of China, the disclosure of which is incorporated herein by reference in its entirety.

### TECHNICAL FIELD

The present application relates to the technical field of air purification, in particular to a two-way air intake purifier.

### BACKGROUND

An air purifier refers to a purification device that can absorb, decompose or transform various air pollutants such as dust and allergens. It can effectively improve the cleanliness of the air and is widely used in households and industries.

Common air purifiers use a centrifugal wind wheel and a filter screen, and purify the air by the centrifugal action of the centrifugal wind wheel to cause airflow disturbance after the air passes through the filter screen. In existing air purification equipment, the air usually enters from one side of the filter screen and exits from the other side. The volume of air intake and outtake is limited, which is not conducive to overall circulation of indoor air, and the air purification efficiency is low.

### SUMMARY

In order to overcome the deficiencies of the prior art, an objective of the present application is to provide a two-way air intake purifier, which can increase the volume of air intake and outtake, facilitate overall circulation of indoor air, and have high air purification efficiency.

The objective of the present application is achieved by the following technical solution.

A two-way air intake purifier, including a body and at least two fans, wherein a first air inlet is provided on each of two opposite sides of the body, a first air outlet is provided on a side adjacent to the two first air inlets on the body, each of the fans has two second air inlets arranged axially and a second air outlet arranged laterally, the fans are all arranged in the body, the two second air inlets of each of the fans are respectively facing the two first air inlets, the second air outlet of each of the fans is facing the first air outlet, and a filtering device is provided at the first air inlets and/or the second air inlets respectively.

Preferably, the fan includes a housing, a centrifugal wind wheel and a driving device, the housing includes a top plate, a bottom plate and a side panel arranged between the top plate and the bottom plate, the top plate and the bottom plate are each provided with the second air inlet, the side panel is provided with the second air outlet, and the centrifugal wind wheel has a first centrifugal wheel body arranged close to the top plate and a second centrifugal wheel body arranged close to the bottom plate; and the driving device is connected to the housing, and an output end of the driving device is connected to the centrifugal wind wheel and drives the centrifugal wind wheel to rotate.

Preferably, the centrifugal wind wheel has a ring structure formed by a plurality of blades, a partition plate is arranged in the ring structure, and the partition plate separates the ring structure into the first centrifugal wheel body close to the top plate and the second centrifugal wheel body close to the bottom plate.

Preferably, the driving device includes a power part and a metal sleeve, the power part is connected to the housing, the metal sleeve is sleeved on an output end of the power part, the centrifugal wind wheel is provided with a plug-in hole, and the metal sleeve is plugged into the plug-in hole.

Preferably, an inner wall of the plug-in hole is provided with a locking slot, an outer wall of the metal sleeve is provided with a locking block corresponding to the locking slot, and the metal sleeve is fixedly connected to the centrifugal wind wheel by the locking block being locked in the locking slot.

Preferably, an end of the power part away from the metal sleeve is provided with a fixing part, the fixing part is connected to the housing, and a buffer pad is provided between the fixing part and the housing.

Preferably, a first connection hole is provided on the fixing part, a second connection hole is provided on the buffer pad, a third connection hole is provided on the housing, and the fixing part and the buffer pad are fixed on the housing after fasteners pass through the first connection hole, the second connection hole and the third connection hole in sequence.

Preferably, the top plates of the fans are sequentially connected to form an integrally formed first plate structure, the bottom plates of the fans are sequentially connected to form an integrally formed second plate structure, the first plate structure and the second plate structure are each provided with a plurality of second air inlets, and a plurality of side panels are arranged between the first plate structure and the second plate structure.

Preferably, the second air inlet is a circular mouth, the second air outlet is a square mouth, and the second air outlet is also provided with a frame-shaped air deflector that forms a guide channel.

Preferably, two or three fans are provided, and the fans are all arranged side by side at intervals in the body.

Compared with the prior art, the present application has the following beneficial effects.

In the two-way air intake purifier, the fan has two second air inlets and one second air outlet, forming a double air intake structure. A plurality of air intake structures are provided in the body. The second air inlets of the fans are all facing the first air inlets of the body, and the second air outlets are all facing the first air outlet of the body, such that air intake can be realized on both sides of the body. Moreover, each first air inlet of the body cooperates with the second air inlets of a plurality of fans for simultaneous air intake, and the first air outlet of the body cooperates with the second air outlets of a plurality of fans for simultaneous air outtake, which can increase the volume of air intake and outtake, facilitate overall circulation of indoor air, and improve air purification efficiency.

### BRIEF DESCRIPTION OF THE DRAWINGS

FIG. 1 is a structure diagram of a two-way air intake purifier according to one embodiment of the present application;

FIG. 2 is a longitudinal sectional structure diagram of the two-way air intake purifier of FIG. 1;

FIG. 3 is a structure diagram of the fan of FIG. 1;

FIG. 4 is a longitudinal sectional structure diagram of the fan in FIG. 3;

FIG. 5 is an enlarged diagram of the structure at A of the fan of FIG. 4;

FIG. 6 is a structure diagram of a two-way air intake purifier according to another embodiment of the present application; and

FIG. 7 is a longitudinal sectional structure diagram of the two-way air intake purifier of FIG. 6.

In the drawings:
100, Two-way air intake purifier;
1, Body; 11, First air inlet; 12, First air outlet; 2, Fan; 21, Second air inlet; 22, Second air outlet; 23, Housing; 231, Top plate; 232, Bottom plate; 233, Side panel; 234, First plate structure; 235, Second plate structure; 24, Centrifugal wind wheel; 241, First centrifugal wheel body; 242, Second centrifugal wheel body; 243, Blade; 244, Partition plate; 245, Plug-in hole; 246, Locking slot; 25, Driving device; 251, Power part; 252, Metal sleeve; 253, Fixing part; 254, Buffer pad; 4, Guide channel.

### DETAILED DESCRIPTION OF THE EMBODIMENTS

Below, the present application will be further described in conjunction with the accompanying drawings and specific embodiments. It should be noted that, on the premise of not conflicting, the various embodiments or technical features described below can be combined arbitrarily to form new embodiments. Unless otherwise specified, the materials and equipment used in the embodiments can be purchased from the market. Examples of the embodiments are shown in the drawings, wherein like or similar reference numerals designate like or similar elements or elements having same or similar functions throughout. The embodiments described below by referring to the figures are exemplary, and are only for explaining this application, and are not understood to limit this application.

In the description of this application, it is to be understood that the orientation or positional relationship indicated by the terms “upper”, “lower”, “front”, “rear”, “vertical”, “horizontal”, “top”, “bottom”, “inner” and “outer” is based on the orientation or positional relationship shown in the drawings, and is only for the convenience of describing the application and simplifying the description, rather than indicating or implying that the referred device or element must have a specific orientation, constructed and operated in a particular orientation and therefore should not be construed as limiting the application. In the description of this application, “plural” means two or more, unless otherwise specified precisely.

In the description of this application, it should be noted that, unless otherwise clearly specified and limited, the terms “connected with”, “communicated with”, and “connected to” should be understood in a broad sense, for example, it can be a fixed connection or a connection through an intermediary media, can be the internal communication of two elements or the interaction relationship between two elements. Those of ordinary skill in the art can understand the specific meanings of the above terms in this application according to specific situations.

The terms “first”, “second” and the like in the description and claims of this application and the above drawings are used to distinguish similar objects, and are not necessarily used to describe a specific order or sequence. Furthermore, the terms “comprising” and “having”, as well as any variations thereof, are intended to cover a non-exclusive inclusion, for example, a process, method, system, product or device including a sequence of steps or elements is not necessarily limited to the explicitly listed steps or elements, instead, may include other steps or elements not explicitly listed or inherent to the process, method, product or device.

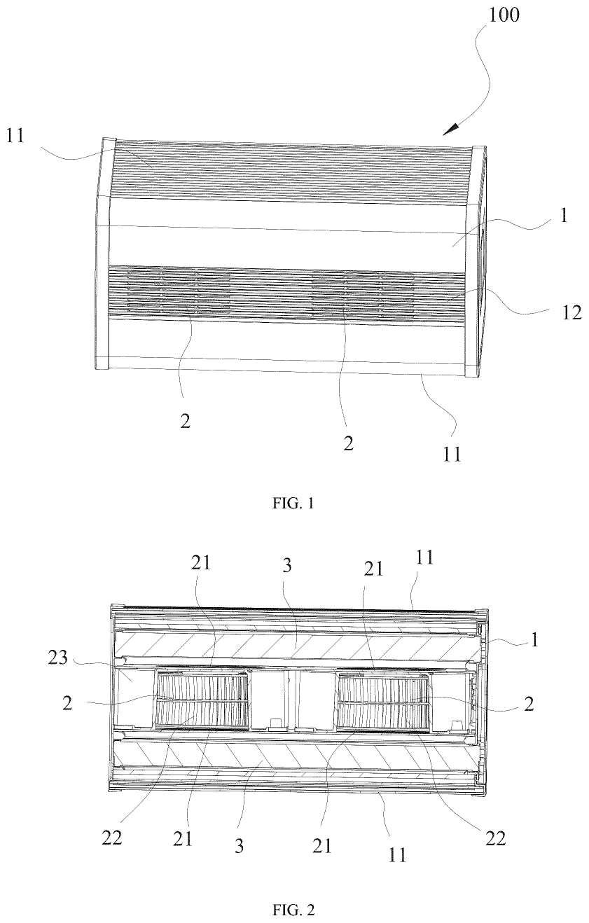

The present application provides a two-way air intake purifier 100. As shown in FIGS. 1 to 7, the two-way air intake purifier 100 includes a body 1 and at least two fans 2. A first air inlet 11 is provided on each of two opposite sides of the body 1. A first air outlet 12 is provided on a side adjacent to the two first air inlets 11 on the body 1. The fan 2 has two second air inlets 21 arranged axially and a second air outlet 22 arranged laterally. The fans 2 are arranged in the body 1. The two second air inlets 21 of each of the fans 2 are respectively facing the two first air inlets 11. The second air outlet 22 of each of the fans 2 is facing the first air outlet 12. A filtering device 3 is provided at the first air inlets 11 and/or the second air inlets 21 respectively. Specifically, the filtering devices 3 may be provided only at the first air inlets 11, or the filtering devices 3 may be provided only at the second air inlets 21, or the filtering devices 3 are provided at both the first air inlets 11 and the second air inlets 21. The filtering devices 3 purify the air and then the air enters the inside of the fans 2 to form an air flow to achieve the effect of purifying the air.

As mentioned above, it can be understood that the fan 2 has two second air inlets 21 and one second air outlet 22, forming a double air intake structure. A plurality of air intake structures are provided in the body 1. The second air inlets 21 of the fans 2 are all facing the first air inlet s11 of the body 1, and the second air outlets 22 are all facing the first air outlet 12 of the body 1, such that air intake can be realized on both sides of the body 1. Moreover, each first air inlet 11 of the body 1 cooperates with the second air inlets 21 of a plurality of fans 2 for simultaneous air intake, and the first air outlet 12 of the body 1 cooperates with the second air outlets 22 of a plurality of fans 2 for simultaneous air outtake, which can increase the volume of air intake and outtake, facilitate overall circulation of indoor air, and improve air purification efficiency.

In some embodiments, as shown in FIGS. 2 to 5, the fan 2 includes a housing 23, a centrifugal wind wheel 24 and a driving device 25. The housing 23 includes a top plate 231, a bottom plate 232 and a side panel 233 arranged between the top plate 231 and the bottom plate 232. The top plate 231 and the bottom plate 232 are each provided with the second air inlet 21. The side panel 233 is provided with the second air outlet 22. The centrifugal wind wheel 24 has a first centrifugal wheel body 241 arranged closed to the top plate 231 and a second centrifugal wheel body 242 arranged close to the bottom plate 232. The driving device 25 is connected to the housing 23. An output end of the driving device 25 is connected to the centrifugal wind wheel 24 and drives the centrifugal wind wheel 24 to rotate. As mentioned above, since the first centrifugal wheel body 241 and the second centrifugal wheel body 242 form two centrifugal wheel bodies to rotate together, the air will enter from the second air inlets 21 of the top plate 231 and the bottom plate 232, the first centrifugal wheel body 241 may blow out the air entering from the second air inlet 21 of the top plate 231 from the second air outlet 22 at the side panel 233, and the second centrifugal wheel body 242 may blow out the air entering from the second air inlet 21 of the bottom plate 232 from the second air outlet 22 at the side panel 233, such that a structure in which the air enters from the top and bottom of the housing 23 axially and then is gathered to the direction of the side for outtake, facilitate overall circulation of indoor air, and improve air purification efficiency.

Specifically, in this embodiment, as shown in FIG. 2, the body 1 has a rectangular parallelepiped structure, the fan 2 has a cylindrical structure, and the bottom plate 232 of the fan 2 is screwed to the inner wall of the body 1 to be fixed in the body 1.

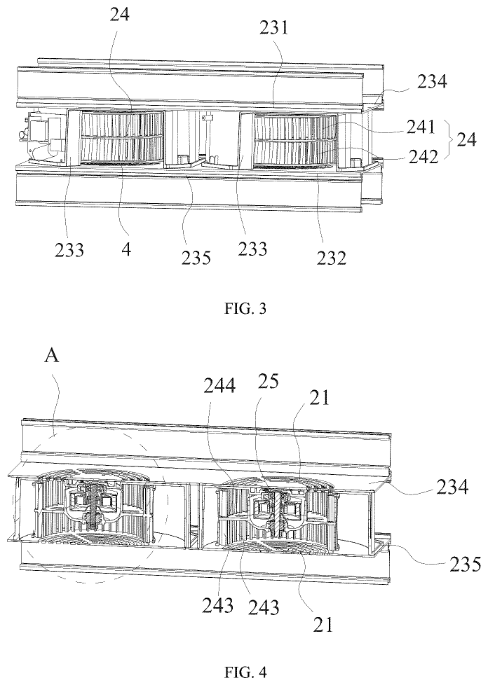

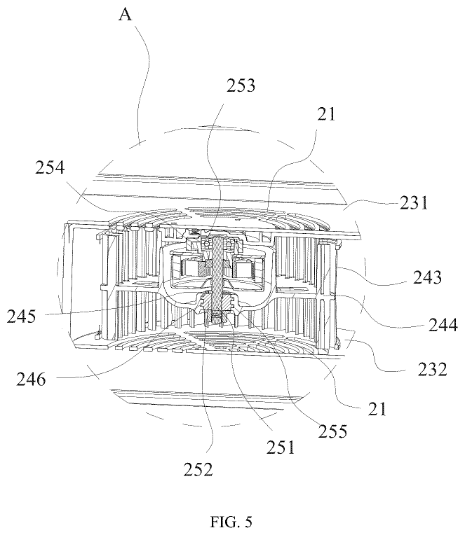

In some embodiments, as shown in FIGS. 3 and 4, the centrifugal wind wheel 24 has a ring structure surrounded by a plurality of blades 243. Specifically in this embodiment, the centrifugal wind wheel 24 also includes two ring frames, and two opposite ends of each of the blades 243 are respectively fixed on the two ring frames to form a stable ring structure. A partition plate 244 is arranged in the ring structure. The partition plate 244 separates the ring structure into a first centrifuge wheel body 241 close to the top plate 231 and a second centrifugal wheel body 242 close to the bottom plate 232. After the air enters the inner side of the centrifugal wind wheel 24, the blades 243 of the first centrifugal wheel body 241 may blow out the air entering from the second air inlet 21 of the top plate 231, the blades 243 of the second centrifugal wheel body 242 may blow out the air entering from the second air inlet 21 of the bottom plate 232, and finally the clean air is blown out from the second air outlet 22 of the side panel 233. Adopting the above up-down two-way air intake structure can increase the air intake volume of the fan 2.

In some embodiments, as shown in FIG. 5, the driving device 25 includes a power part 251 and a metal sleeve 252. The power part 251 is connected to the housing 23. The metal sleeve 252 is sleeved on an output end of the power part 251. The centrifugal wind wheel 24 is provided with a plug-in hole 245. The metal sleeve 252 is plugged into the plug-in hole 245. Specifically in this embodiment, the power part 251 is connected to the top plate 231 of the housing 23 and is located in the interior space of the housing 23. The partition plate 244 of the centrifugal wind wheel 24 is provided with a plug-in hole 245, such that the power part 251 can synchronously drive the first centrifugal wheel body 241 and the second centrifugal wheel body 242 to rotate synchronously, and the fan 2 can form an up-down synchronous air intake structure. In addition, the arrangement of the metal sleeve 252 can provide radial and axial load capacity and reduce friction loss and surface wear.

In some embodiments, as shown in FIG. 5, an inner wall of the plug-in hole 245 is provided with a locking slot 246, and an outer wall of the metal sleeve 252 is provided with a locking block 255 corresponding to the locking slot 246. The metal sleeve 252 is fixedly connected to the partition plate 244 of the centrifugal wind wheel 24 by the locking block 255 being locked in the locking slot 246, such that when the power part 251 drives the metal sleeve 252 to rotate, it can also drive the centrifugal wind wheel 24 fixedly connected to the metal sleeve 252 to rotate synchronously.

In some embodiments, as shown in FIG. 5, an end of the power part 251 away from the metal sleeve 252 is provided with a fixing part 253. The fixing part 253 is connected to the housing 23. A buffer pad 254 is provided between the fixing part 253 and the housing 23. It can be understood that the fixing part 253 is connected to the top plate 231 of the housing 23 and is located in the interior space of the housing 23, such that the power part 251 is fixed in the interior space of the housing 23. The buffer pad has a buffering function, and its arrangement between the fixing part 253 and the housing 23 can form elastic buffer for the vibration generated by the power part 251 during operation, thereby reducing the impact of the vibration generated by the power part 251 during operation on the housing 23 and the body 1. Specifically, the buffer pad 254 may be a soft rubber pad, as long as it has a buffer function, which is not limited here.

In some embodiments, as shown in FIG. 5, the fixing part 253 is provided with a first connection hole, the buffer pad 254 is provided with a second connection hole, and the housing 23 is provided with a third connection hole. The fixing part 253 and the buffer pad 254 are fixed on the housing 23 after fasteners pass through the first connection hole, the second connection hole and the third connection hole in sequence. Specifically in this embodiment, the first connection hole, the second connection hole and the third connection hole may all be threaded holes, and fasteners such as screws pass through the first connection hole, the second connection hole and the third connection hole sequentially by threading to threadedly fix the fixing part 253 on the housing 23, which has characteristics of stable connection and convenient assembly and disassembly. Certainly, in other embodiments, the connection between the fixing part 253 and the housing 23 is not limited to screw connection, and other connections such as locking, bonding or pin connection are applicable.

In some embodiments, as shown in FIGS. 3 and 4, the top plates 231 of the fans 2 are sequentially connected to form an integrally formed first plate structure 234, and the bottom plates 232 of the fans 2 are sequentially connected to form an integrally formed second plate structure 235. The first plate structure 234 and the second plate structure 235 are each provided with a plurality of second air inlets 21. A plurality of side panels 233 are arranged between the first plate structure 234 and the second plate structure 235. One centrifugal wind wheel 24 is arranged inside each side panel 233. Therefore, by forming a plurality of double air intake structures between the two plates, the structure can be made compact and easy to assemble.

In some embodiments, the power part 251 is an electric motor. An output shaft of the motor is located at the axle center of the centrifugal wind wheel 24 and is connected to the partition plate 244 of the centrifugal wind wheel 24. The centrifugal wind wheel 24 can be smoothly driven to rotate by the motor.

In one embodiment, as shown in FIGS. 1 and 4, the first air inlets 11 and the first air outlet 12 of the body 1, and the second air inlets 21 of the fans 2 are all mesh holes, such that the distribution of the holes is more uniform, the air intake is uniform, and it is more aesthetically pleasing.

In some embodiments, as shown in FIGS. 3 and 4, the second air inlet 21 is a circular mouth, and the second air outlet 22 is a square mouth. The second air outlet 22 is also provided with a frame-shaped air deflector to form a guide channel 4. It can be understood that the second air inlet 21 being a circular mouth and the second air outlet 22 being a square mouth can adapt to the cylindrical structure of the centrifugal wind wheel 24, such that the second air inlets 21 adapt to the shapes of the axial ends of the centrifugal wind wheel 24 and facilitate the air flow of the centrifugal wind wheel 24 to be guided out from the guide channel 4 at the second air outlet 22.

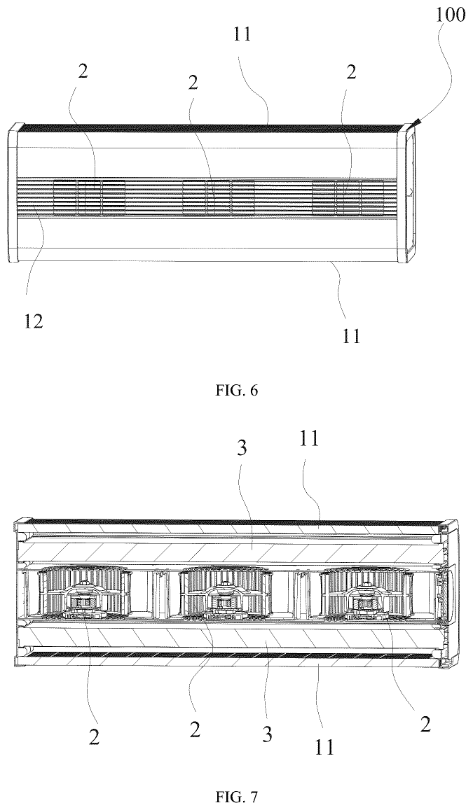

In some embodiments, as shown in FIGS. 1 and 2, two fans 2 are provided. In other embodiments, as shown in FIGS. 6 and 7, three fans 2 are provided. The fans 2 are arranged side by side at intervals in the body 1. It can be understood that two or three fans 2 being arranged in the body 1 to jointly circulate and push the air, on the one hand, can effectively improve the air fluidity and improve the air purification effect of the entire indoor space under the premise of ensuring a compact structure. In other embodiments, the number of the fans 2 may be specifically set according to actual needs, which is not limited here.

The above embodiments are only preferred embodiments of the present application, and shall not be used to limit the scope of protection of the present application. Any insubstantial changes and replacements made by those skilled in the art on the basis of the present application all belong to the scope of protection required by the present application.

What is claimed is:

1. A two-way air intake purifier, comprising a body and at least two fans, wherein a first air inlet is provided on each of two opposite sides of the body, a first air outlet is provided on a side adjacent to the two first air inlets on the body, each of the fans has two second air inlets arranged axially and a second air outlet arranged laterally, the fans are all arranged in the body, the two second air inlets of each of the fans are respectively facing the two first air inlets, the second air outlet of each of the fans is facing the first air outlet, and a filtering device is provided at the first air inlets and/or the second air inlets respectively.

2. The two-way air intake purifier according to claim 1, wherein the fan comprises a housing, a centrifugal wind wheel and a driving device, the housing comprises a top plate, a bottom plate and a side panel arranged between the top plate and the bottom plate, the top plate and the bottom plate are each provided with the second air inlet, the side panel is provided with the second air outlet, and the centrifugal wind wheel has a first centrifugal wheel body arranged close to the top plate and a second centrifugal wheel body arranged close to the bottom plate; and the driving device is connected to the housing, and an output end of the driving device is connected to the centrifugal wind wheel and drives the centrifugal wind wheel to rotate.

3. The two-way air intake purifier according to claim 2, wherein the centrifugal wind wheel has a ring structure formed by a plurality of blades, a partition plate is arranged in the ring structure, and the partition plate separates the ring structure into the first centrifugal wheel body close to the top plate and the second centrifugal wheel body close to the bottom plate.

4. The two-way air intake purifier according to claim 2, wherein the driving device includes a power part and a metal sleeve, the power part is connected to the housing, the metal sleeve is sleeved on an output end of the power part, the centrifugal wind wheel is provided with a plug-in hole, and the metal sleeve is plugged into the plug-in hole.

5. The two-way air intake purifier according to claim 4, wherein an inner wall of the plug-in hole is provided with a locking slot, an outer wall of the metal sleeve is provided with a locking block corresponding to the locking slot, and the metal sleeve is fixedly connected to the centrifugal wind wheel by the locking block being locked in the locking slot.

6. The two-way air intake purifier according to claim 4, wherein an end of the power part away from the metal sleeve is provided with a fixing part, the fixing part is connected to the housing, and a buffer pad is provided between the fixing part and the housing.

7. The two-way air intake purifier according to claim 6, wherein a first connection hole is provided on the fixing part, a second connection hole is provided on the buffer pad, a third connection hole is provided on the housing, and the fixing part and the buffer pad are fixed on the housing after fasteners pass through the first connection hole, the second connection hole and the third connection hole in sequence.

8. The two-way air intake purifier according to claim 2, wherein the top plates of the fans are sequentially connected to form an integrally formed first plate structure, the bottom plates of the fans are sequentially connected to form an integrally formed second plate structure, the first plate structure and the second plate structure are provided with a plurality of second air inlets, and a plurality of side panels are arranged between the first plate structure and the second plate structure.

9. The two-way air intake purifier according to claim 2, wherein the second air inlet is a circular mouth, the second air outlet is a square mouth, and the second air outlet is also provided with a frame-shaped air deflector that forms a guide channel.

10. The two-way air intake purifier according to claim 1, wherein two or three fans are provided, and the fans are all arranged side by side at intervals in the body.
